(19) United States
(12) Patent Application Publication
(10) Pub. No.: US 2013/0297928 A1
(43) Pub. Date: Nov. 7, 2013

(54) Field device with long-term firmware compatability

(71) Applicants: Jurg Wyss, Ettingen (CH); Marco Colucci, Lorrach (DE); Andre Elle, Rumminmgen (DE)

(72) Inventors: Jurg Wyss, Ettingen (CH); Marco Colucci, Lorrach (DE); Andre Elle, Rumminmgen (DE)

(21) Appl. No.: 13/997,324

(22) PCT Filed: Nov. 23, 2011
(86) PCT No.: PCT/EP2011/070862

§ 371 Date: Jun. 24, 2013

(30) Foreign Application Priority Data
Dec. 28, 2010 (DE) 10 2010 064 279.7

(51) Int. Cl. G06F 9/445

(52) U.S. Cl. CPC G06F 9/44505
USPC 713/100

(57) ABSTRACT

A field device having at least one memory and at least two replaceable modules, each of which has hardware and firmware associated with the hardware. In such case, firmware version information of a compatible firmware version combination of the modules of the field device is stored in the at least one memory or such is storable therein at a first-time start-up of the field device. Furthermore, the field device is embodied in such a manner that a comparison in the case of at least one module of its firmware version with the firmware version information stored in the memory is automatically performable and that the module is automatically switchable to the firmware version as claimed in the firmware version information, in case the comparison shows a deviation of the firmware version of the module from the firmware version of the firmware version information stored for the corresponding module.

The present invention relates to a field device as defined in the preamble of claim 1 as well as to a method for long-term maintenance of the firmware compatibility of a field device.

In process automation technology, field devices are often applied, which serve for registering and/or influencing process variables. Serving for registering process variables are sensors, such as, for example, fill level measuring devices, flow measuring devices, pressure- and temperature measuring devices, pH-redox potential measuring devices, conductivity measuring devices, etc., which register the corresponding process variables, fill level, flow, pressure, temperature, pH-value, and conductivity. Serving for influencing process variables are actuators, such as, for example, valves or pumps, via which the flow of a liquid in a pipeline section or the fill level in a container can be changed. Referred to as field devices are, in principle, all devices, which are applied near to the process and deliver or process information relevant to the process. A large number of such field devices are produced and sold by the firm, Endress+Hauser.

In modern industrial plants, field devices are, as a rule, connected via a data transmission system with superordinated units. The data transmission system can be formed, for example, by a wireless and/or wired, bus system (e.g. a Profibus®, Foundation® Fieldbus, HART®, etc. system) or by an electrical current loop (e.g. according to the 4-20 mA standard). The superordinated units are, as a rule, control systems, or control units, such as, for example, a PLC (programmable logic controller). The superordinated units serve, among others things, for process control, process visualizing, process monitoring as well as for start-up of the field devices.

Field devices contain, as a rule, a number of modules, or assemblies, each of which can involve hardware and firmware associated with the hardware. At the manufacturer, the individual modules are so combined with one another and their firmware so matched to one another that the firmware of the individual modules of the field device are compatible with one another (internal compatibility, or internal interoperability). The total software of the field device is formed, or generated, from the firmware of the individual modules of a field device (and, in given cases, additional firmware and/or software components of the field device). The total software is decisive for the interoperability of the field device (as a whole) externally, especially with third-party devices (external compatibility, or external interoperability). External compatibility is achieved, as a rule, by providing, for the relevant field device, information for device integration corresponding to its total software (for example, a device description or a device driver). A third-party device (for example, an operating tool or an engineering tool) can then access this information for device integration (in that the information is, for example, implemented and/or stored in the third-party device) and interact and communicate with the relevant field device based on this information for device integration. In order to enable for a user a simple associating of appropriate information for device integration with a relevant field device, as a rule, a separate version number is issued specifically for the total software,. Based on this version number of the total software, a user can then determine the appropriate information for device integration, without having to be concerned with the versions of the individual firmwares of the modules.

Over the course of time, manufacturers create new firmware versions for the individual modules. This means that the modules of newly provided field devices often have other firmware versions than the modules of older field devices. The firmware versions of newly provided field devices are then, in turn, matched to one another, so that internal compatibility exists. Furthermore, there is provided, in turn, corresponding information for device integration for the newly produced field devices, so that external compatibility is enabled.

During the life cycle of a field device, the case can occur, in which a module of the field device must be replaced (for example, because the installed module has become defective). A newly ordered module or a module from the warehouse of the user has, as a rule, especially when it was manufactured at another point in time, a different firmware version and, in given cases, also a modified version of the hardware. If such a module is installed in the field device, then there is basically the problem that the firmware of the newly installed module will, as a rule, not be compatible with the firmware of the other modules of the field device (lack of internal compatibility) and/or that the total software of the field device will be modified due to the replacement in such a manner that the previously used information for device integration will no longer provide external compatibility. Especially when the module in question must, due to a malfunction, be rapidly replaced, these problems of lacking internal and/or external compatibility can in part not be removed. Especially, it is often the case that, at the time for such a replacement, no sufficiently schooled technicians are present to perform the required adaptations. As a result, this can lead to a plant shutdown.

This problem can partially be removed when the user in the case of failure of a module requests from the manufacturer a new module, which has the same firmware version as the module previously installed in the field device. This can, however, lead to a longer downtime of the relevant field device and is associated with increased consumption of time on the part of the manufacturer. This problem can also be counteracted when the manufacturer builds the firmware versions of the different modules of a field device in such a manner that, at least for basic functions, both internal as well as also external compatibility is present for the different possible firmware version combinations of the individual modules of the field device. The higher the number of possible firmware versions for the individual modules and the higher the number of modules within a field device, the higher is the effort for the manufacturer to provide such internal as well as also external compatibility for the different possible firmware version combinations.

Accordingly, an object of the present invention is to provide a field device, which has at least two replaceable modules, each of which has hardware and firmware associated with the hardware, and to provide a corresponding method. These should accomplish that over the life of the field device, even in the case of replacement of one or more modules of the same, firmware compatibility of the firmware of the individual modules is maintainable.

The object is achieved by a field device as defined in claim 1 as well as by a method as defined in claim 12. Advantageous further developments of the invention are set forth in the dependent claims.

The field device of the invention, which is formed especially by a sensor and/or an actuator, includes at least one memory and at least two replaceable modules, each of which has hardware and firmware associated with the hardware. Stored in the at least one memory is firmware version information of a compatible firmware version combination of the modules of the field device or such is storable therein at a first-time start-up of the field device. Furthermore, the field device is embodied in such a manner that a comparison in the case of at least one module of the field device (especially in the case of all modules of the field device) of its firmware version with the firmware version information stored in the memory is automatically performable and that the (particular) module is automatically switchable to the firmware version of the firmware version information, in case the comparison shows a deviation of the firmware version of the module from the firmware version of the firmware version information stored for the corresponding module.

Accordingly, embodying of the field device according to the invention assures that there is stored therein, at least after its first start-up, firmware version information concerning a compatible firmware version combination and, after replacement of a module automatically the newly installed module with the firmware version is operable according to the firmware version information. In this way, all modules of the field device are operated with firmware version corresponding to the compatible firmware version combination, so that, as a whole, the compatible firmware version combination is maintained. In case a module of the field device is replaced, thus, neither for the user nor for the manufacturer is there any additional effort, in order to provide the correct firmware version for the module. Furthermore, it is not required that, after replacement of a module, changed information must be provided in a third-party device (for example, in an operating tool or an engineering-tool) for device integration. Accordingly, the required effort as well as the risk of an error related to replacement of a module can be reduced. By embodying the field device according to the invention, internal as well as also external compatibility can be assured over the life of the field device.

In such case, the field device can come from the factory with firmware version information corresponding to an initial firmware version combination stored in the at least one memory or such can be stored therein upon first-time start-up of the field device. One variant is, thus, that in which the firmware version information is already stored in the field device in the at least one memory when the field device comes from the factory. And an alternative variant is that the field device is embodied in such a manner that the firmware version information is automatically stored in the memory upon first-time start-up of the field device (after its delivery) corresponding to the, initial firmware version combination present in the field device and from this point in time then serves as continued reference (except when an upgrade is performed, such as will be explained below). Accordingly, the at least one memory can, at delivery, first of all, contain no firmware version information. Furthermore, the manufacturer can also provide other firmware version information of one or more additional, compatible firmware version combination(s), which the user can load subsequently as “upgrades” into the field device. In this way, the field device can subsequently be switched to another compatible firmware version combination, especially to a newer, compatible firmware version combination (upgrading). Alternatively to an upgrade, in equal manner, also switching to an older, compatible firmware version combination (downgrading) is possible. The alternative of a downgrade will not be mentioned explicitly each time. Effort for the manufacturer is reduced, since internal compatibility, as well as also external compatibility (by providing, in each case, corresponding information for device integration) must be assured for only a limited number of compatible firmware version combinations. In the case of all variants, it is especially provided that always exactly one compatible firmware version combination is decisive, that its associated firmware version information (at least after the first-time start-up of the field device) is stored in the memory and that the compatible firmware version combination forms a reference in the field device, to which the firmware(s) of individual or multiple modules are brought into conformity in the case of a deviation. The firmware version combination, whose associated firmware version information is stored in the memory, forms, thus, a type master, which determines, with which firmware the individual modules of the field device are operated. In such case, it is in the firmware version information especially unequivocally determined, with which firmware versions the individual modules are to be operated, so that the associated, compatible firmware version combination results.

The terminology “field device” refers especially to a sensor or to an actuator (e.g. a control valve). Especially sensors have frequently (such as will be explained with reference to the figures) a number of modules. The sensor can, for example, be in the form of a flow measuring device. Alternatively, the sensor can also be formed by a pressure measuring device, a temperature measuring device, a fill level-measuring device, a pH-measuring device, etc. The field device can be embodied as a compact device (i.e. all parts of the same are embodied on or in one housing) or as a distributed device, in the case of which at least two parts are arranged separately from one another and communicate with one another (wired or wirelessly). An example of a distributed embodiment is one in which the measuring transducer of a field device is emplaced in the field, while at least one part of the electronics of the field device, which performs processing, evaluation and/or transformation of the measurement signal, is embodied and arranged separately from the field device. The separately embodied and arranged part of the electronics (e.g. a measurement transmitter) can be arranged, for example, in a control room, especially in a circuitry cabinet. “Replaceability” of the modules means that these can be individually deinstalled and replaced with a new module. Such a replacement can, in given cases, comprise a number of steps, such as, for example, the releasing of screws, the separating and renewed connecting of lines, etc.

In a further development, the at least one memory, in which the firmware version information is stored, is formed by exactly one memory. In this way, the firmware version information is available centrally in the field device. Alternatively, it can, however, also be stored in more than one memory, i.e. distributed. The at least one memory is especially durably available in the field device. The firmware version information can, in such case, also be stored compressed in the memory, such as is known in the technical field.

Referred to as firmware, such as usual in the technical field, is embedded software, which is connected functionally with the associated hardware (of the respective module). Especially, in the individual modules, the hardware is not operable without the associated firmware and vice versa. The compatible firmware version combination is a combination of firmware versions of the different modules of the field device, such that these are compatible both internally as well as also externally (especially by providing appropriate information for device integration for the therefrom resulting, total software). The compatible firmware version combination forms a firmware version combination especially authorized by the manufacturer. For example, such is provided by the manufacturer of the field device (already with delivery of the field device from the factory and/or for a subsequent upgrade). The field device is especially embodied in such a manner that the automated performing of the comparison and the automated switching of the relevant module to the proper firmware version occurs without user interaction. In this way, it is prevented that due to an intervention of the user, other than the compatible firmware version combination is present in the field device.

Fundamentally, both the case can occur, in which the module, in the case of which the comparison and, in given cases, a switching is/are performed, first of all, has a newer firmware version than the firmware version according to the firmware version information. This case can especially occur when in the field device an old module is replaced with a new module. Alternatively, the module, for which the comparison and, in given cases, a switching is/are performed, can initially also have an older firmware version than the firmware version according to the firmware version information.

To the extent in this connection that reference is to “at least one”, reference is to exactly one as well as also to the possibility of more than one. This holds even though this is not explicitly mentioned each time (except for cases where “exactly one is called for). This understanding holds especially in the case of the at least one memory.

In a further development, the compatible firmware version combination corresponds to a firmware version combination present at delivery of the field device (initial firmware version combination). In this way, it is assured that the field device is operated over its lifetime with this compatible initial firmware version combination (to the extent that no upgrade is performed).

In a further development, the field device is embodied in such a manner that, after a starting of the same, the comparison is performed automatically for all modules of the field device and, in given cases, automatic switching of one or more modules to firmware versions occurs according to the firmware version information. “All modules” refers to the modules of the field device, for which information concerning their firmware is stored in the firmware version information. In this way, it is assured that after each starting of the field device all modules are operated with the firmware according to the compatible firmware version combination. Since, after a replacement of a module of a field device, the field device is, as a rule, restarted, it can be assured that exactly when changes could possibly have occurred, all modules can be reset to the compatible firmware version combination. Additionally or alternatively, it can also be provided that, in regular time intervals and/or on the initiative of a user, the comparison and, in given cases, the switching is/are performed.

In a further development, the firmware version information has the firmware of the modules, in each case, in the firmware version of the compatible firmware version combination. Since all firmware is stored in the at least one memory, such can, when required, be simply loaded into the relevant module. In a further development, the field device is embodied in such a manner that, in the context of the automatic switching of a module to the firmware version according to the firmware version information, the firmware appropriate for this module is loaded from the firmware version information into the module and activated therein. Especially, in such case, the firmware previously provided in the module is overwritten. A special embodying of the individual modules of the field device is not required for this. These further developments are especially advantageous as regards performing an upgrade of the firmware version information. For, in this way, also firmware with newer firmware versions (than the firmware versions previously provided in the modules) can be stored as upgrades in the memory and the modules of the field device can so be switched to newer firmware versions. In such case, the firmware version information can, especially in the case of this further development, be stored in compressed form in the at least one memory.

In a further development, at least one module is embodied in such a manner that it is operable in different firmware versions and that, as a function of the result of the comparison in the module, the firmware version according to the firmware version information is activatable. Especially, all modules of the field device, for which information concerning their firmware is stored in the firmware version information, are embodied in such a manner. In an additional development, it is, furthermore, provided that the firmware version information has information concerning the firmware versions of the compatible firmware version combination, but, however, not the firmware of the compatible firmware version combination. Accordingly, the firmware version information forms a kind of information matrix relative to the firmware versions to be used in the individual modules. In the case of this further development, the firmware version information requires only relatively little memory capacity. In contrast, the individual modules are comparatively extensively embodied, since in these, in each case, a number of firmware versions are provided, of which then, in each case, one is activated. In reference to performing an upgrade, it is in the case of these further developments problematic that provided in the individual modules are, as a rule, only firmware versions, which already existed at the point in time of their respective deliveries.

In a further development, the field device includes a processor unit, which can perform the automatic comparison and the automatic switching, in each case, in reference to all modules of the field device. In this way, the performing of the comparison and the switching, if such is warranted, is/are centrally controlled. A particular embodying of the modules is not required for this further development. The processor unit can especially be formed by a central processing unit of the field device. It can alternatively also be provided integrally in a module of the field device, such as, for example, in a measurement amplifier module. Alternatively, it can, however, also be provided that the individual modules are embodied in such a manner that they perform the comparison and, in given cases, the switching self-sufficiently. In given cases, they can also themselves trigger the performing of these steps.

In a further development, the at least one memory is embodied in the field device independently of the modules of the field device. In this way, it is assured that the memory is unaffected by the replacement of one or more modules of the field device. The at least one memory can be formed, for example, by (at least one) ROM (read only memory). Especially, exactly one memory is provided centrally for all modules of the field device for storing the firmware version information.

In a further development, the field device includes at least one of the following modules, wherein more than one of each of the following modules can also be provided:

a) a central processing unit;

b) a measurement amplifier module;

c) a sensor module;

d) a user interface module; and/or

e) a communication interface module.

Alternatively and/or supplementally, also yet other modules can be provided. The particular embodiment depends on the construction and the functions of the field device. Furthermore, it is not absolutely required that the central processing unit be embodied as a separate module. Especially, also two or more of the above listed modules can be embodied integrally as one module. For example, the measurement amplifier module and/or the communication interface module can form together with the central processing unit integrally one module.

In a further development, the field device is embodied in such a manner that at least one of the following pieces of information is/are storable in the at least one memory and/or capable of being read out from the at least one memory:

f) configuration parameters of at least one module of the field device; and/or

g) information for device integration of the field device.

Especially, this information is stored in the at least one memory. By storing the configuration parameters, after replacement of a module (or also after a putting a module back in place), the associated configuration parameters can in simple manner be downloaded from the memory and into the module. In this way, the module is directly operable in the right configuration, without that the user must set corresponding configuration parameters for this. Especially, the steps of downloading the configuration parameters from the memory and the loading of the same into the relevant module can be performed automatically. Preferably, the configuration parameters for all modules of the field device, which have configuration parameters, are stored in the memory. Since the information for device integration of the field device is stored in the memory, such is centrally available in the field device. In this way, problems of associating, which information to use for device integration for the relevant field device, are prevented. In case an upgrade is performed, also the appropriate information for device integration can be stored in the memory together with the firmware version information. The information for device integration can thus be transmitted, in simple manner, (in given cases, even automatically) to a third-party device (for example, an operating tool or an engineering tool), by which the field device is serviced, for example.

In a further development, the information for device integration of the field device comprises especially a device description and/or a DTM (DTM: Device Type Manager) of the field device. The information for device integration, i.e. means for device integration, of a field device serves to make known to a third-party device (for example, an operating tool or an engineering tool) the properties of the field device relevant for servicing. As a rule, the information for device integration essentially comprises information concerning the functions implemented in the field device and data contained in the field device. Especially, it comprises, as a rule, the input- and output signals delivered by the relevant field device, information relative to communication of the field device via a fieldbus, parameters provided in the field device, status- and diagnostic information delivered by the field device, data and rules for procedures (e.g. configuring, calibrating) and/or information concerning user interfaces, etc. In order to be able to service different field devices, especially field devices of different manufacturers, via one and the same operating tool, standards were created for this information for device integration. On the one hand, information for device integration of a field device comprises, for example, a device description (DD) of the field device. The device description is, as a rule, created in text-based form (e.g. in the ASCII-text format). For this, depending on applied fieldbus-system, different device description languages are used, such as, for example, the HART® Device Description Language, Foundation® Fieldbus Device Description Language, Electronic Device Description Language (EDDL), Field Device Configuration Markup Language, GSD/Profibus (GSD: General Station Description). The information provided in the device description is, as a rule, interpreted by an interpreter, respectively translated, and provided to the operating tool, which forms a frame application for the device description. Furthermore, information for device integration of a field device includes, for example, a device driver of the field device, especially a “Device Type Manager” (DTM). A device driver, especially a “Device Type Manager”, is, in such case, a device-specific software, which encapsulates data and functions of the field device and provides graphical servicing elements. Such a device driver requires for execution a corresponding frame application, for example, a “Device Type Manager” requires a FDT-frame application (FDT: Field Device Tool) for its execution. An operating program, which forms such an FDT-frame application, is, for example, the “FieldCare0” program of Endress+Hauser.

The present invention relates, furthermore, to a method for long-term maintenance of firmware compatibility of a field device, especially a sensor and/or an actuator. The field device includes at least one memory and at least replaceable two modules, each of which has hardware and firmware associated with the hardware. The method includes steps as follows:

A) storing firmware version information of a compatible firmware version combination of the modules of the field device in the at least one memory;

B) automated performing of a comparison in the case of at least one module of the field device of its firmware version with the firmware version information stored in the memory; and

C) automated switching of the module to the firmware version of the firmware version information, in case the comparison shows a deviation of the firmware version of the module from the firmware version of the firmware version information stored for the corresponding module.

In the case of the method of the invention, essentially the same advantages are achieved as explained in reference to the field device of the invention. Furthermore, the above explained further developments and variants are implementable in corresponding manner. Especially, the steps of automated performing of a comparison (compare step B)) and automated switching (compare step C)) can be performed also a number of times, for example, each time after the starting of the field device, or regularly, for example, in regular time intervals. Furthermore, also the storing of the firmware version information (compare step A)) can occur a number of times during the lifetime of the field device (for example, in case a later upgrade is performed).

In a further development, the step of the storing is performed by the manufacturer of the field device or at a first-time start-up of the field device. Especially, in such case, firmware version information of an original firmware version combination (initial firmware version combination), such as is present at delivery of the field device from the factory, is stored. In combination with performing the steps of automated performing of a comparison (compare step B)) and automated switching (compare step C)), it is thus durably assured that the field device is operated in the initial firmware version combination.

In a further development, the step of the storing is performed after a first-time start-up of the field device. In such case, firmware version information of a compatible firmware version combination, which differs from the original firmware version combination (initial firmware version combination) of the field device, is stored. In this way, especially subsequently, an upgrade of the firmware of the modules of the field device and therewith an upgrade of the total software of the field device can be performed. The firmware version information for such an upgrade can especially be provided to a user by the manufacturer. The user can download this firmware version information, for example, from a manufacturer's web page. In such case, it can be provided that the field device has (at least) two memories, or memory ranges, which are respectively individually activatable. In such case, stored in a first memory (respectively, memory range) is the previously determinative firmware version information, while the new firmware version information is loadable into a second memory (respectively, memory range). After loading the new firmware version information, then the second memory (respectively, memory range) can be activated and the first memory (respectively, memory range) deactivated. Thus a switching to new firmware version information can occur, without having to experience any extended downtime of the field device.

Other advantages and utilities of the invention will become evident based on the following description of examples of embodiments with reference to the appended drawing, the figures of which show as follows:

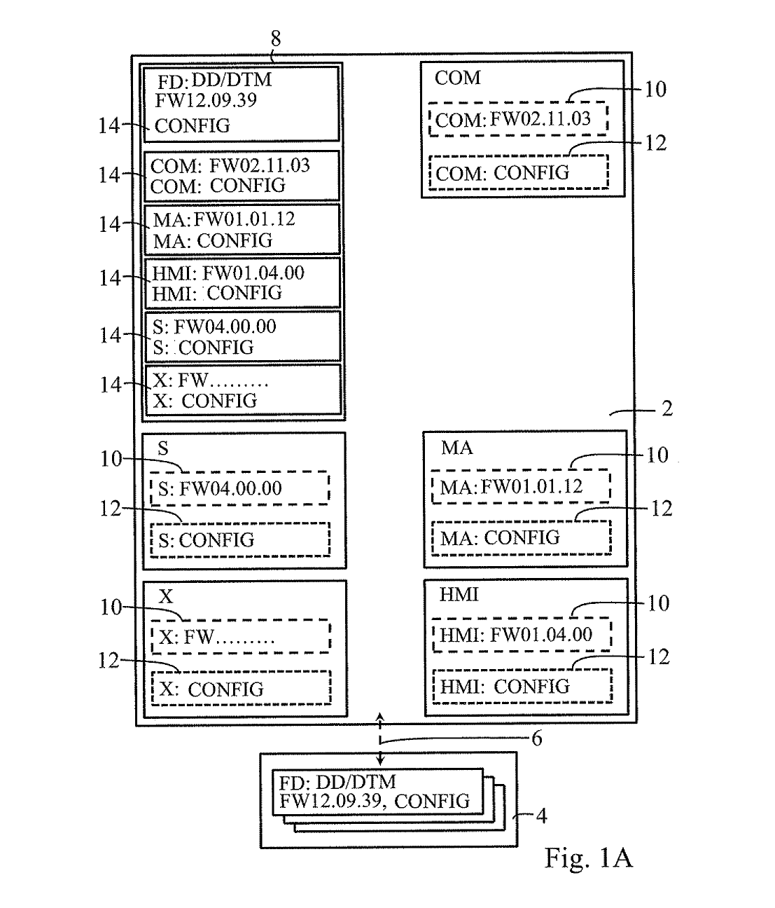

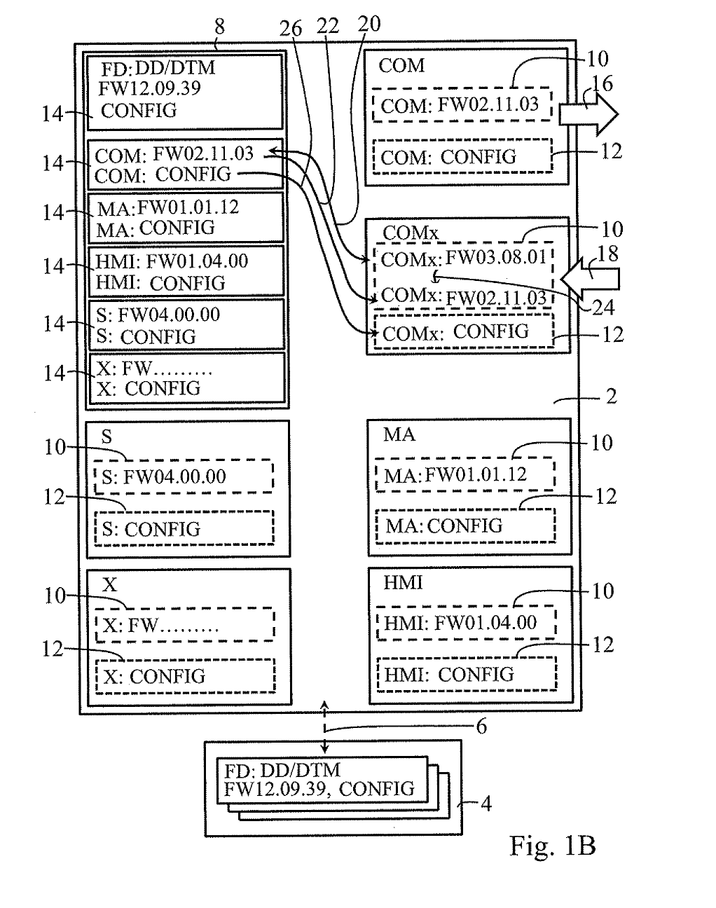

FIG. 1A a schematic representation of a field device according to a first form of embodiment of the invention, coupled with a service device;

FIG. 1B the field device and service device of FIG. 1A, wherein the method of the invention is illustrated based on replacement of a module of the field device;

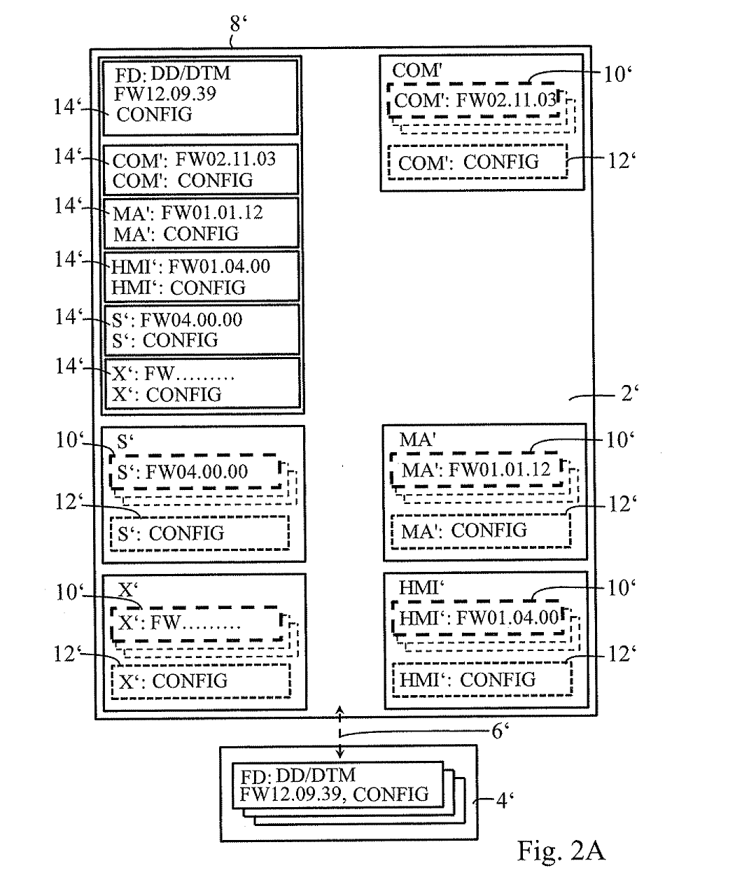

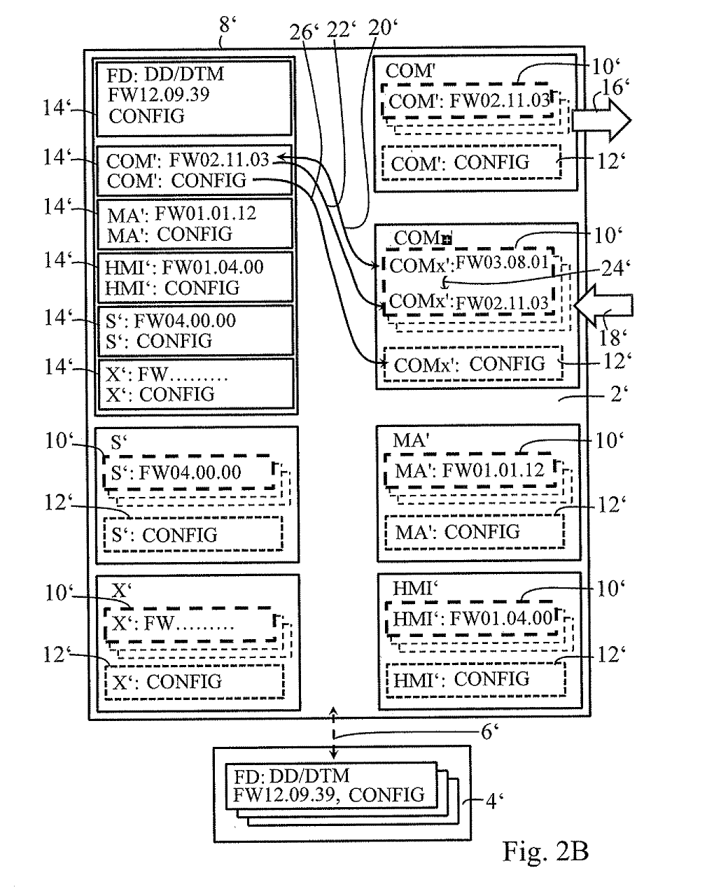

FIG. 2A a schematic representation of a field device according to a second form of embodiment of the invention, again coupled with a service device; and

FIG. 2B the field device and service device of FIG. 2A, wherein the method of the invention is illustrated based on replacement of a module of the field device.

FIG. 1A shows a field device 2 in the form of a sensor, here a flow measuring device. Field device 2 is in communication connection via a data transmission system 6 with a service device 4, in which an operating tool is implemented. Data transmission system 6 of the illustrated form of embodiment is formed by a fieldbus 6 (in this case, a HART® fieldbus 6). Field device 2 contains a central memory 8. Furthermore, the field device 2 includes a measurement amplifier module MA, a sensor module S, a user interface module HMI and a communication interface module COM. The sensor module S includes the sensor unit of the field device 2 and is embodied in such a manner that it can provide a measurement signal characteristic for the measured variable to be registered. The measurement amplifier module MA is embodied in such a manner that it can process, such as, for example, amplify, transform, smooth, etc., the measurement signal provided by the sensor module S. The user interface module HMI includes in the case of the present form of embodiment a display- and interaction unit and an associated electronics. Depending on the embodiment of the field device 2 it can, however, also have only a service unit. The communication interface module is embodied in such a manner that communication can be performed with the field device 2 via the particular data transmission system (here, fieldbus) 6. Besides these, the field device can have yet other modules, such as indicated in FIG. 1A schematically by the other module X.

Each module MA, S, HMI, COM and X is composed of hardware and firmware associated with the hardware. The firmware version of the respective firmware is specified in each case by a firmware version number. This firmware version number is shown for each module MA, S, HMI, COM and X in the long dash boxes 10. Especially, the measurement amplifier module MA has the firmware version FW01.01.12, the sensor module S the firmware version FW04.00.00, the user interface module HMI the firmware version FW01.04.00 and the communication interface module COM the firmware version FW02.11.03. Furthermore, each module is configured corresponding to its intended functionality, which is accomplished by corresponding settings of the configuration parameters of the respective module. The specific configuration parameters of the individual modules are indicated in FIG. 1A for each module MA, S, HMI, COM and X, in each case, by the short dash box 12 with the label “CONFIG”.

The firmware of the individual modules MA, S, HMI, COM and X are members of a compatible firmware version combination. Especially, internal compatibility, as well as also external compatibility exists. Such compatible firmware version combination can be a compatible initial firmware version combination, such as provided by the manufacturer in the field device 2 as the field device 2 comes from the factory. If an upgrade of the firmware version information was already performed by the user of the field device 2, the compatible firmware version combination can also be one provided by the manufacturer and differing from the initial firmware version combination.

Stored in the central memory 8, which is embodied independently of the modules MA, S, HMI, COM and X of the field device 2, is the firmware version information of the compatible firmware version combination. The firmware version information contains for each module MA, S, HMI, COM and X the firmware of the firmware version of the compatible firmware version combination. This is shown in FIG. 1A schematically by the individual blocks 14 within the memory 8 associated with the respective modules (as well as the service device 4). In these blocks 14, in each case, the firmware version numbers of the different modules MA, S, HMI, COM and X are presented. Further stored in memory 8 are, in each case, the configuration parameters (respectively, their settings) of the different modules MA, S, HMI, COM and X, this being indicated in FIG. 1A by the “CONFIG” statements in the individual blocks 14.

In the case of the present form of embodiment, the firmware of the individual modules of the field device 2 form the total software of the field device 2. This total software is, as above explained, decisive for the interoperability of the field device 2 (as a whole) with third-party devices—here, the service device 4. The total software of the field device was given the version number FW12.09.39. This version number is, as a rule, placed in the field device in such a manner that it can be easily accessed by a user. Based on this version number of the total software, then the user can select the appropriate information for device integration, especially the suitable device description DD and/or the matching device driver DTM. The service device 4 requires the matching information for device integration, in order to be able to service the field device 2 specifically (compare “FD:DD/DTM FW 12.09.39” in FIG. 1A within the service device 4). In the case of the illustrated form of embodiment, the information for device integration of the field device 2, thus information developed corresponding to the total software present in the field device 2, is stored in the memory 8.

This is indicated in FIG. 1A schematically by the block 14 with the label “FD: DD/DTM FW12.09.39”. Furthermore, for servicing the field device 2, the relevant configuration parameters, which are to be set in the service device 4, are likewise stored in the memory 8 (compare “CONFIG” in the same block 14, as well as “CONFIG” within the service device 4). In this way, the information for device integration as well as the associated settings of the configuration parameters appropriate for the field device 2 do not need to be manually selected, or set, by a user. The service device 4 can download these automatically via the fieldbus 6. Furthermore, in the case of performing an upgrade of the firmware version information, it is advantageous that, together with the new firmware version information, also the appropriate information for device integration, as well as, in given cases, the associated settings of the configuration parameters for the service device, can be loaded into the memory 8. In this way, errors caused through incorrect selection by the user are prevented.

In the following, with reference to FIG. 1B, the case will now be explained, in which a module of the field device illustrated in FIG. 1A is replaced (for example, due to a defect of the same) by a new module. In this case, the communication interface module COM is replaced by a new communication interface module COMx (compare arrows 16 and 18 in FIG. 1B). For performing this replacement, the field device 2 is temporarily turned off. The firmware of the newly installed module COMx is present in the firmware version FW03.08.01, while the firmware of the previous module COM was present in the firmware version FW02.11.03. Accordingly, there is a deviation from the compatible firmware version combination, for which the associated firmware version information is stored in the memory 8. After the replacement of the module COM by COMx, the field device 2 is restarted. After restarting the field device 2, for all modules MA, S, HMI, COMx and X of the field device 2, a comparison of their respective firmware versions with the firmware version information stored in the memory 8 is automatically performed. This comparison is performed for all modules MA, S, HMI, COMx and X centrally by a processor unit (not shown), which is integrated in the present form of embodiment in the measurement amplifier module MA. The performing of the comparison is indicated in FIG. 1B in reference to the module COMx schematically by the double arrow 20. In the present case, the comparison shows, such as was explained above, a deviation of the firmware version of the module COMx (here: FW03.08.01) from the firmware version stored for the module COM (here: FW02.11.03) of the firmware version information. Accordingly, the module COMx is switched automatically to the firmware version according to the firmware version information (here: FW02.11.03). In the case of the illustrated form of embodiment, this occurs by loading the firmware for the module COMx from the firmware version information stored in the memory 8 into the module COMx (the firmware previously provided in the module COMx is, in such case, over-written) and activated therein (compare arrows 22, 24 in FIG. 1B). Then, the configuration parameters “CONFIG” for the module COMx are loaded from the memory 8 into the module COMx (compare arrow 26 in FIG. 1B). The steps of switching and loading of the configuration parameters are, in turn, performed by the processor unit, which is integrated in the measurement amplifier module MA. The steps of switching and loading achieve that the module COMx is operated with the firmware version corresponding to the compatible firmware version combination and with the configuration settings of the corresponding module COM previously provided in the field device. The steps of performing the comparison, switching and loading are performed, in such case, automatically without interaction of a user.

A second form of embodiment of the present invention will now be explained with reference to FIGS. 2A and 2B. In such case, primarily the differences compared with the first form of embodiment will be explained. For equal or corresponding components, equal reference characters are used, wherein these are each provided with a prime mark. FIG. 2A corresponds to FIG. 1A, apart from the differences to be explained. In contrast to the first form of embodiment, the individual modules MA′, S′, HMI′, COM′ and X′ are each embodied to be operable with different firmware versions. This is indicated schematically in FIG. 2A by the pluralities of long dash boxes 10′, wherein the respectively activated firmware version is placed in front in bold. For example, provided in each module MA′, S′, HMI′, COM′ and X′ can be all firmware versions, which were created up to its date of delivery.

The firmware of the individual modules MA′, S′, HMI′, COM′ and X′ are present again in a compatible firmware version combination. Stored in the central memory 8′, which is embodied independently of the modules MA′, S′, HMI′, COM′ and X′ of the field device 2′, is firmware version information of the compatible firmware version combination. The firmware version information has, in the case of this second form of embodiment, information concerning the firmware versions of the compatible firmware version combination, not, however, the firmware of the compatible firmware version combination. Accordingly, the firmware version information forms a kind of information matrix relative to the firmware versions to be used in the individual modules MA′, S′, HMI′, COM′ and X′. The storing of the firmware version information in the memory 8′ is indicated schematically in FIG. 2A by the individual blocks 14′ within the memory 8′ referencing the respective modules (as well as the service device 4′). In each case, the firmware version numbers of the different modules MA′, S′, HMI′ and COM′ are given. Further stored in the memory 8′ again are the configuration parameters (respectively, their settings) of the different modules MA′, S′, HMI′, COM′ and X′. This is indicated in FIG. 2A by the “CONFIG” in the individual blocks 14′ presented.

Now, with reference to FIG. 2B, in turn, the case will be explained, wherein a module (here the communication interface module COM′) of the field device 2′ illustrated in FIG. 2A is replaced by a new module (here the communication interface module COMx′) (compare arrows 16′ and 18′ in FIG. 2B). Regarding the course of events, reference is made to the description of FIG. 1B, combined with the differences to be explained below. The activated firmware version in the newly installed module COMx′ is FW03.08.01, whereas the firmware version activated in the previous module COM′ was FW02.11.03. Accordingly, a deviation is detected in the case of the (automatically performed) comparison of the activated firmware version of the newly installed module COMx′ with the firmware version information stored in the memory 8 (compare double arrow 20′ in FIG. 25). Accordingly, the module COMx′ is switched automatically to the firmware version according to the firmware version information (here: FW02.11.03). In the case of the illustrated form of embodiment, this occurs in that, instead of the previously activated firmware version FW03.08.01 in the module COMx′, the firmware version FW02.11.03 is activated (compare arrows 22′, 24′ in FIG. 2B). Then, again, the configuration parameters “CONFIG” associated with the module COMx′ are loaded from the memory 8′ into the module COMx′ (compare arrow 26′ in FIG. 2B). These steps of switching and loading achieve that the module COMx′ is operated with the firmware version corresponding to the compatible firmware version combination and with the corresponding configuration settings of the module COM′ previously provided in the field device 2′. The steps of performing the comparison, switching and loading are, in such case, automatically performed without interaction by a user.

1-14. (canceled)

15. A field device, especially a sensor and/or an actuator, comprising:
at least one memory; and
at least two replaceable modules, each of which has hardware and firmware associated with the hardware, wherein:
firmware version information of a compatible firmware version combination of said modules of the field device is stored in said at least one memory or such is storable therein at a first-time start-up of the field device;
the field device is embodied in such a manner that a comparison in the case of at least one module of the field device of its firmware version with the firmware version information stored in said at least one memory is automatically performable; and
the module is automatically switchable to the firmware version according to the firmware version information, in case the comparison shows a deviation of the firmware version of the module from the firmware version of the firmware version information stored for the corresponding module.

16. The field device as claimed in claim 15, wherein:
the compatible firmware version combination corresponds to a firmware version combination, such as is present at delivery of the field device.

17. The field device as claimed in claim 15, wherein:
the field device is embodied in such a manner that, after a starting of the same, the comparison is performed automatically for all modules of the field device and, in given cases, switching of one or more of the modules to the firmware version as claimed in the firmware version information occurs automatically.

18. The field device as claimed in claim 15, wherein:
the firmware version information contains the firmwares of the modules, in each case, in the firmware version of the compatible firmware version combination.

19. The field device as claimed in claim 18, wherein:
the field device is embodied in such a manner that, in the context of the automatic switching of a module to the firmware version as claimed in the firmware version information, the firmware corresponding to this module is loaded from the firmware version information into the module and activated therein.

20. The field device as claimed in claim 15, wherein:
at least one module is embodied in such a manner that it is operable in different firmware versions and that, as a function of the result of the comparison, the firmware version as claimed in the firmware version information is activatable in said module.

21. The field device as claimed in claim 20, wherein:
the firmware version information contains information concerning the firmware versions of the compatible firmware version combination, not, however, the firmware of the compatible firmware version combination.

22. The field device as claimed in claim 15, wherein:
the field device has a processor unit, which can perform the automatic comparison and the automatic switching, in each case, in reference to all modules of the field device.

23. The field device as claimed in claim 15, wherein:
said at least one memory is embodied in the field device independently of the modules of the field device.

24. The field device as claimed in claim 16, wherein:
the field device contains at least one of the following modules:
a) a central processing unit;
b) a measurement amplifier module;
c) a sensor module;
d) a user interface module; and/or
e) a communication interface module.

25. The field device as claimed in claim 24, wherein:
the field device is embodied in such a manner that in said at least one memory at least one of the following pieces of information is/are storable and/or at least one of the following pieces of information is/are capable of being read out from said at least one memory:
f) configuration parameters of at least one module of the field device; and/or
g) information for device integration of the field device.

26. A method for long-term maintenance of firmware compatibility of a field device, especially a sensor and/or an actuator, which field device includes at least one memory and at least two replaceable modules, each of which has hardware and firmware associated with the hardware, comprising the steps of:
storing firmware version information of a compatible firmware version combination of the modules of the field device in the at least one memory;
automated performing of a comparison in the case of at least one module of the field device of its firmware version with the firmware version information stored in the memory; and
automated switching of the module to the firmware version of the firmware version information, in case the comparison shows a deviation of the firmware version of the module from the firmware version of the firmware version information stored for the corresponding module.

27. The method as claimed in claim 26, wherein:
step of storing is performed by the manufacturer of the field device or at a first-time start-up of the field device and firmware version information of an original firmware version combination, such as present at delivery of the field device, is stored.

28. The method as claimed in claim 26, wherein:
the step of storing is performed after a first-time start-up of the field device and firmware version information of a compatible firmware version combination, which differs from the original firmware version combination of the field device, is stored.
